(19) United States
(12) Patent Application Publication
(10) Pub. No.: US 2026/0064063 A1
(43) Pub. Date: Mar. 5, 2026

(54) IMAGE FORMING APPARATUS THAT DETERMINES COLOR MISREGISTRATION AMOUNT

(71) Applicant: CANON KABUSHIKI KAISHA, Tokyo (JP)

(72) Inventors: YASUHIKO OKUMA, Shizuoka (JP); TAKUYA MUKAIBARA, Shizuoka (JP)

(21) Appl. No.: 19/314,603

(22) Filed: Aug. 29, 2025

(30) Foreign Application Priority Data
Sep. 2, 2024 (JP) 2024-150878

(51) Int. Cl. G03G 15/00; G03G 15/01; G06K 15/02

(52) U.S. Cl. CPC G03G 15/5058; G03G 15/0189; G06K 15/027; G03G 2215/0158; G06K 2215/0094

(57) ABSTRACT

An image forming apparatus includes: a control unit configured to form, onto an image carrier, a detection pattern including a first image group including a plurality of first images and a second image group including a plurality of second images, and determine a color misregistration amount in a rotational direction and a width direction orthogonal to the rotational direction based on a detection result of the detection pattern. The detection pattern includes a plurality of basic patterns arranged at a first interval in the rotational direction, and each of the plurality of basic patterns includes the first image group and the second image group arranged at a second interval in the rotational direction, and the first image group and the second image group arranged at a third interval different from the second interval in the rotational direction.

### BACKGROUND

### Field of the Technology

The present disclosure relates to a color misregistration correction technique in an image forming apparatus.

### Description of the Related Art

In an image forming apparatus that forms a color image by forming images of different colors on a plurality of photoreceptors and transferring the images formed on the respective photoreceptors to be superimposed on a transfer belt, a color misregistration can occur due to a mechanical factor or an environmental factor. The color misregistration includes a steady color misregistration (hereinafter, DC color misregistration) that does not depend on a position in a rotational direction of the transfer belt and a non-steady color misregistration (hereinafter, AC color misregistration) that changes depending on the position in the rotational direction of the transfer belt. The AC color misregistration occurs due to factors such as eccentricity of a rotator such as a photoreceptor and a transfer belt, eccentricity of a driving member such as a motor that drives the rotator, and thickness unevenness of the transfer belt.

In order to suppress the DC color misregistration, the image forming apparatus performs color misregistration correction processing. Specifically, the image forming apparatus forms a detection pattern including images of respective colors on the transfer belt, and detects a relative positional relationship between the images of the respective colors included in the detection pattern. Then, the image forming apparatus determines the color misregistration amount of the DC color misregistration of an image of another color with respect to an image of a reference color based on the detection result of the detection pattern. The image forming apparatus generates a correction parameter for suppressing the color misregistration of each color based on the determined color misregistration amount. Performing image formation based on the correction parameter can suppress the DC color misregistration. Here, when the AC color misregistration occurs in the color misregistration correction processing, depending on arrangement on the transfer belt of each image of the detection pattern, an error occurs in the color misregistration amount of the DC color misregistration to be determined in the color misregistration correction processing due to an influence of the AC color misregistration, and the DC color misregistration remains.

US-2017-0329267 discloses a detection pattern for performing color misregistration correction processing with a suppressed influence of AC color misregistration. According to US-2017-0329267, a first image group and a second image group inclined oppositely to each other with respect to a conveyance direction (moving direction) of the surface of the transfer belt are alternately arranged at equal intervals along the conveyance direction.

The AC color misregistration can occur not only with a period in which a rotator or a motor that drives the rotator makes one rotation as one period, but also with a period in which the rotator or the motor that drives the rotator makes 1/M rotations as one period. Here, M is an integer of 2 or more. In the following description, the AC color misregistration with a period in which a rotator or a motor that drives the rotator makes one rotation as one period is referred to as a “basic AC color misregistration”. The AC color misregistration with a period in which a rotator or a motor that drives the rotator makes 1/M rotations as one period is referred to as an “M-th order AC color misregistration”.

When the first image group and the second image group are alternately arranged at equal intervals along the conveyance direction of the transfer belt, there can be a case where an influence of the M-th order AC color misregistration cannot be suppressed. In this case, due to the influence of the M-th order AC color misregistration, an error remains in the color misregistration amount of the DC color misregistration to be determined in the color misregistration correction processing.

### SUMMARY

According to an aspect of the present disclosure, an image forming apparatus includes: a plurality of photoreceptors that are rotationally driven and on which images of different colors are formed; an image carrier that is rotationally driven and to which images formed on the plurality of photoreceptors are transferred; a detection unit configured to detect an image transferred to the image carrier; and a control unit configured to form, onto the image carrier, a detection pattern including a first image group including a plurality of first images of different colors and a second image group including a plurality of second images of different colors by forming a first image and a second image on each of the plurality of photoreceptors to transfer the first image and the second image to the image carrier, and determine a color misregistration amount in a rotational direction of the image carrier and a color misregistration amount in a width direction orthogonal to the rotational direction based on a detection result of the detection pattern by the detection unit, wherein the first image is a linear image in a first direction different from the rotational direction, the second image is a linear image in a second direction different from the rotational direction and the first direction, the detection pattern includes a plurality of basic patterns arranged at a first interval in the rotational direction, and each of the plurality of basic patterns includes the first image group and the second image group arranged at a second interval in the rotational direction, and the first image group and the second image group arranged at a third interval different from the second interval in the rotational direction.

Features of the present disclosure will become apparent from the following description of embodiments with reference to the attached drawings. The following description of embodiments are described by way of example.

### BRIEF DESCRIPTION OF THE DRAWINGS

The accompanying drawings, which are incorporated in and constitute a part of the specification, illustrate embodiments of the present disclosure, and together with the description, serve to explain the principles of the embodiments.

FIG. 1 is a control configuration diagram of an image forming apparatus according to some embodiments.

FIG. 2 is a configuration diagram of a printer engine according to some embodiments.

FIG. 3 is a configuration diagram of a mechanism according to some embodiments.

FIGS. 4A and 4B are explanatory views of a sensor according to some embodiments.

FIG. 5 is a view illustrating an image group pair according to some embodiments.

FIG. 6 is an explanatory view of a detection method of an image by a sensor.

FIG. 7 is an explanatory view of a determination principle of a color misregistration amount in a width direction.

FIG. 8 is a view illustrating an arrangement example of a basic pattern according to some embodiments.

FIG. 9 is a view illustrating a basic pattern according to one embodiment.

FIG. 10 is a flowchart of color misregistration correction processing according to some embodiments.

FIG. 11 is an explanatory view of a phase difference between a first image group and a second image group with respect to a third order AC color misregistration.

FIG. 12 is a view illustrating a basic pattern according to one embodiment.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

### First Embodiment

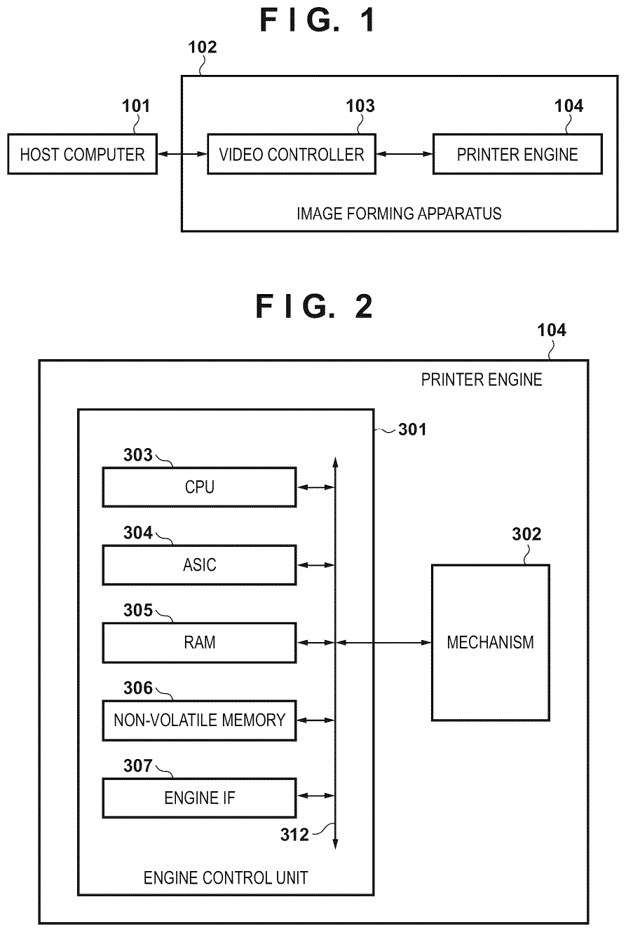

FIG. 1 is a configuration diagram of an image forming system including an image forming apparatus 102 according to the present embodiment. When instructed to form an image from a host computer 101, a video controller 103 of the image forming apparatus 102 performs various types of image processing such as color conversion and halftone processing with respect to image data to be received together with the instruction, and transmits processed image data to a printer engine 104. The printer engine 104 forms an image on a sheet based on the image data from the video controller 103.

FIG. 2 is a schematic configuration diagram of the printer engine 104. A central processing unit (CPU) 303 of an engine control unit 301 executes a control program stored in a nonvolatile memory 306, thereby controlling a mechanism 302 to form an image on a sheet. At that time, the CPU 303 uses a random access memory (RAM) 305 as a main memory and a work area. An application specific integrated circuit (ASIC) 304 also controls the mechanism 302 for image formation on a sheet under the control of the CPU 303. An engine interface (IF) 307 is a communication unit with the video controller 103. Each functional block of the engine control unit 301 is configured in a communication-enabling manner with each other via a system bus 312.

Note that the ASIC 304 can be configured to execute some or all of the functions to be described as being executed by the CPU 303. The CPU 303 can be configured to execute some or all of the functions to be described as being executed by the ASIC 304. Furthermore, further dedicated hardware (not illustrated) is provided, and the hardware can be configured to execute some or all of the functions to be described as being executed by the CPU 303 or the ASIC 304.

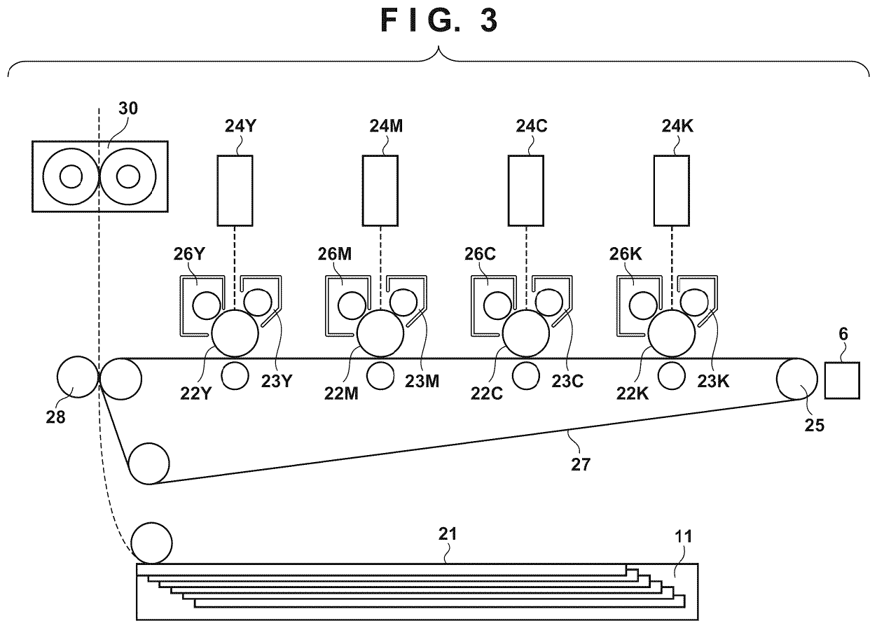

FIG. 3 is a cross-sectional view of the mechanism 302 illustrated in FIG. 2. In FIG. 3, letters Y, M, C, and K at the end of reference signs indicate that the colors of images in which members indicated by the reference signs are related to formation are yellow, magenta, cyan, and black, respectively. In the following description, when it is not necessary to distinguish the color of an image in which the members are related to formation, reference signs excluding letters at the end are collectively used. A photoreceptor 22 is rotationally driven in a counterclockwise direction in the drawing at the time of image formation. A charging unit 23 charges the surface of the photoreceptor 22 to a uniform potential. An optical scanning unit 24 forms an electrostatic latent image on the photoreceptor 22 by scanning, with light based on image data, the photoreceptor 22 to be rotationally driven. A rotation axis direction of the photoreceptor 22 is referred to as a main scanning direction. A rotational direction of the photoreceptor 22 is referred to as a sub-scanning direction. The main scanning direction and the sub-scanning direction are orthogonal to each other. A developing unit 26 forms an image (toner image) on the photoreceptor 22 by developing, with toner, the electrostatic latent image formed on the photoreceptor 22. The image formed on the photoreceptor 22 is transferred to a transfer belt 27, which is an image carrier. Note that a full-color image is formed on the transfer belt 27 by superimposing images of the respective photoreceptors 22 to transfer them to the transfer belt 27.

The transfer belt 27 is rotationally driven in a clockwise direction in the drawing by a driving roller 25 at the time of image formation. By this, the image on the transfer belt 27 is conveyed to an opposing position of a transfer roller 28. On the other hand, a sheet 11 stored in a cassette 21 is conveyed to the opposing position of the transfer roller 28 in accordance with the timing at which the image on the transfer belt 27 is conveyed to the opposing position of the transfer roller 28. The transfer roller 28 transfers the image on the transfer belt 27 to the sheet 11. After the image is transferred, the sheet 11 is conveyed to a fixing unit 30. The fixing unit 30 fixes the image to the sheet 11 by heating and pressurizing the sheet 11. After the image is fixed, the sheet 11 is discharged outside the image forming apparatus 102. A sensor 6 is provided at an opposing position of the transfer belt 27, and detects a detection pattern formed on the transfer belt 27 in the color misregistration correction processing.

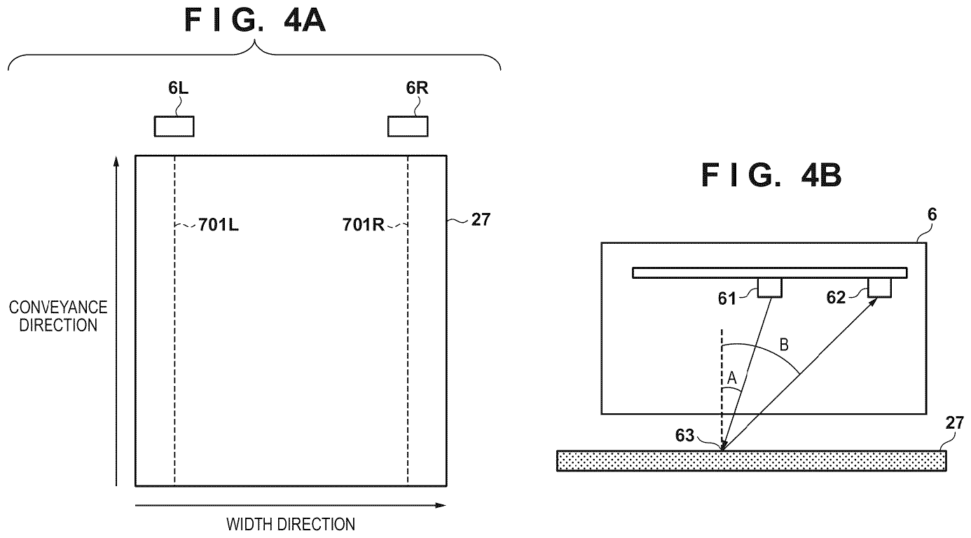

FIG. 4 is an explanatory view of the sensor 6 according to the present embodiment. As illustrated in FIG. 4A, the sensor 6 is a generic term for a sensor 6L and a sensor 6R provided at different positions in the width direction orthogonal to the conveyance direction of the surface of the transfer belt 27. Note that the conveyance direction corresponds to the sub-scanning direction of the photoreceptor 22, and the width direction corresponds to the main scanning direction of the photoreceptor 22. The conveyance direction is also a rotational direction of the transfer belt 27. FIG. 4B is a configuration diagram of the sensor 6. A light emitting unit 61 is, for example, a light emitting diode (LED), and irradiates an area including an irradiation position 63 of the transfer belt 27 with light. A light receiving unit 62 is, for example, a phototransistor, and receives reflected light on the surface of the transfer belt 27 or a detection pattern formed thereon, the light being emitted by the light emitting unit 61. As illustrated in FIG. 4B, the light emitting unit 61 and the light receiving unit 62 are arranged such that an angle A of a straight line connecting the light emitting unit 61 and the irradiation position 63 with reference to a normal direction of the transfer belt 27 is different from an angle B of a straight line connecting the light receiving unit 62 and the irradiation position 63. By this, the light receiving unit 62 receives irregular reflection light from the transfer belt 27 and the detection pattern. The light receiving unit 62 transmits, to the engine control unit 301, a detection signal indicating a received light level (received light intensity or received light amount). Note that another light receiving unit that mainly detects regular reflection light may be further provided.

The sensor 6 irradiates an area including the irradiation position 63 with light, and detects a detection pattern based on the reflected light. Therefore, an area irradiated with light by the sensor 6 including the irradiation position 63 is a detection area of the detection pattern by the sensor 6. A straight line 701L in FIG. 4A connects the irradiation position 63 of light by the sensor 6L changed by rotation of the transfer belt 27, and a straight line 701R in FIG. 4A connects the irradiation position 63 of light by the sensor 6R changed by rotation of the transfer belt 27. In order to detect the detection pattern by the sensor 6L, it is necessary to form the detection pattern on the straight line 701L, and in order to detect the detection pattern by the sensor 6R, it is necessary to form the detection pattern on the straight line 701R. In the following description, the position on the straight line 701L is also referred to as a detectable position 701L of the sensor 6L, and the position on the straight line 701R is also referred to as a detectable position 701R of the sensor 6R. When the sensors 6L and 6R are not distinguished from each other, the detectable position 701L and the detectable position 701R are collectively referred to as a detectable position 701.

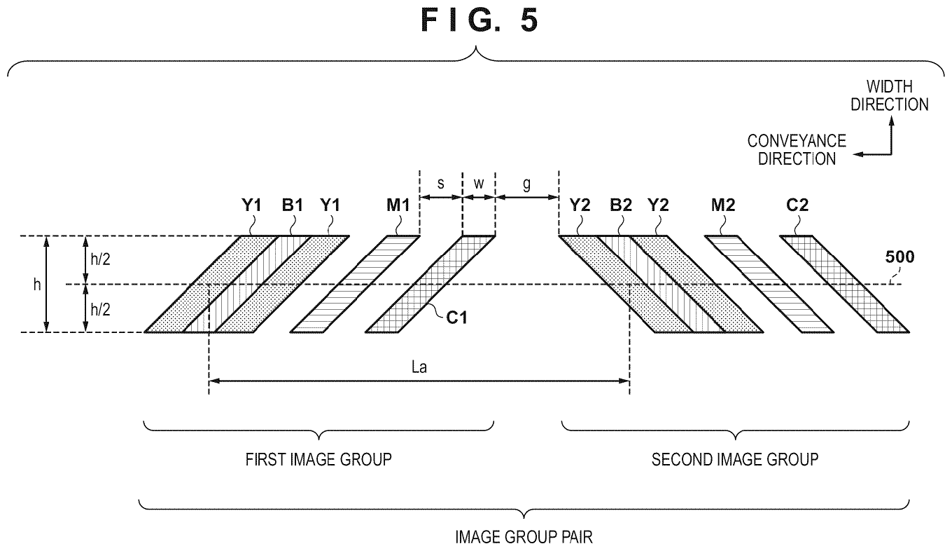

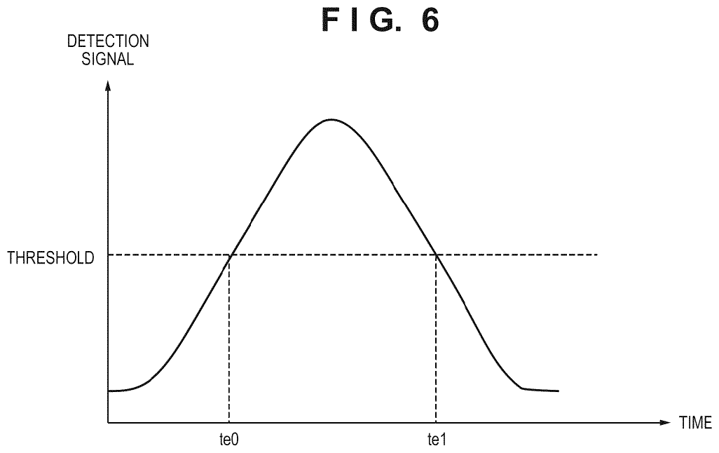

Next, an image group pair constituting a detection pattern formed on the transfer belt 27 in the color misregistration correction processing will be described. Note that in the following description, unless otherwise obvious from the context or otherwise specified, expressions regarding the direction and order such as “front side” and “rear side” are based on the conveyance direction of the transfer belt 27. FIG. 5 illustrates an image group pair. The image group pair includes a first image group and a second image group. The first image group includes images Y1, B1, M1, and C1 having linear shapes inclined by 45 degrees with respect to the conveyance direction. The image Y1 is an image in yellow, the image B1 is an image in black, the image M1 is an image in magenta, and the image C1 is an image in cyan. In the present embodiment, the image B1 is formed on the image Y1. Note that as illustrated in FIG. 5, the image Y1 is divided into a front portion (hereinafter, referred to as a front image Y1) and a rear portion (hereinafter, referred to as a rear image Y1) by the image B1. The reason that the image B1 is formed on the image Y1 will be described later.

The second image group includes images Y2, B2, M2, and C2 corresponding to the images Y1, B1, M1, and C1, respectively. In the present embodiment, the respective images of the second image group are the corresponding images of the first image group inverted about the conveyance direction. That is, in the present embodiment, the first image group and the second image group are line-symmetric with respect to the conveyance direction. As described above, since the first image group and the second image group are line-symmetric with respect to the conveyance direction, the first image group will be described below, and the description of the second image group will be omitted.

As illustrated in FIG. 5, a non-formation area where no image is formed is provided between the image M1 and the image C1 and between the rear image Y1 and the image M1, and the length (hereinafter, non-formation length) in the conveyance direction is s. The length (hereinafter, image length) in the conveyance direction of each of the front image Y1, the image B1, the rear image Y1, the image M1, and the image C1 is w. Furthermore, the length (hereinafter, image width) in the width direction of each of the front image Y1, the image B1, the rear image Y1, the image M1, and the image C1 is h.

As described above, in the present embodiment, the sensor 6 receives irregular reflection light from each image of the transfer belt 27 and the detection pattern. Here, the light emitted from the sensor 6 is mainly regularly reflected on the surface of the transfer belt 27, and the light emitted from the sensor 6 is mainly irregularly reflected on images in yellow, cyan, and magenta. Therefore, when images in yellow, cyan, and magenta are present within the detection area of the sensor 6, the received light level (received light intensity or received light amount) of the sensor 6 becomes larger than that when the surface (non-formation area) of the transfer belt 27 is present within the detection area of the sensor 6.

FIG. 6 illustrates a detection signal when the image M1 passes through the detection area of the sensor 6. As described above, since the reflection modes of light on the image M1 and the surface of the transfer belt 27 are different, when the image M1 passes through the detection area of the sensor 6, the detection signal once increases and then decreases. The engine control unit 301 assumes a timing te0 at which a detection signal exceeds a threshold as a detection timing of a front edge of the image M1, and assumes a timing te1 at which a detection signal falls below the threshold as a detection timing of a rear edge of the image M1. Then, the engine control unit 301 assumes an average value of the two detection timings te0 and te1 as a detection timing of the image M1. The average value of the two detection timings te0 and te1 can be regarded as the detection timing of a substantial center in the conveyance direction of the image M1. The same applies to the image C1.

Next, the reason that the image B1 is formed on the image Y1 will be described. In an image in black, regularly reflected light and irregularly reflected light are reduced by absorption of light. For this reason, the received light level of the sensor 6 does not greatly change between when the image in black is present within the detection area of the sensor 6 and when the surface (non-formation area) of the transfer belt 27 is present within the detection area of the sensor 6. Therefore, even if the image B1 is formed by providing non-formation areas on both the front side and the rear side, as in the image M1 and the image C1, the image B1 cannot be detected. For this reason, in the present embodiment, the image B1 is formed in a partial area of the image Y1.

When the front image Y1, the image B1, and the rear image Y1 sequentially pass through the detection area of the sensor 6, the received light level of the sensor 6 changes as if the level of the detection signal of FIG. 6 is inverted. Therefore, the engine control unit 301 assumes a timing te0 at which a detection signal falls below a threshold as a detection timing of a front edge of the image B1, and assumes a timing te1 at which a detection signal exceeds the threshold as a detection timing of a rear edge of the image B1. Since the received light level of the sensor 6 when the image B1 is present within the detection area is low, the rear image Y1 (or the front image Y1) can be detected as described with reference to FIG. 6. Note that the threshold used to determine the detection timing of the edge can be different for each color of the image.

In this manner, the image B1 is formed on the image Y1 in order to detect an image of each color by the light receiving unit 62 that receives irregular reflection light from the transfer belt 27 and the detection pattern. Note that in the present embodiment, the image B1 is formed on the image Y1, but the image B1 may be configured to be formed on the image M1 or the image C1. When the sensor 6 is provided with a light receiving unit that receives regular reflection light from the transfer belt 27 and the detection pattern, it is not necessary to form the image B1 on an image of another color. In this case, the image Y1, the image B1, the image M1, and the image C1 with non-formation areas provided therebetween can be determined to be the first image group.

In the following description, as illustrated in FIG. 5, the shortest distance of the non-formation area between the image C1 that is the last of the first image group and the image Y2 that is the first of the second image group is g. On a straight line 500 passing through the center in the width direction of each image, the distance between the center position in the conveyance direction of the front image Y1 and the center position in the conveyance direction of the front image Y2 is referred to as an image group interval La. The image group interval La is also a distance between the center position in the conveyance direction of a certain image of the first image group and the center position in the conveyance direction of a corresponding image of the second image group. The image group pair is formed such that the straight line 500 matches the detectable position 701 of the sensor 6.

Next, a method of obtaining the color misregistration amount in the conveyance direction and the width direction from the detection result by the sensor 6 of the image group pair illustrated in FIG. 5 will be described. Note that the following description assumes that black is a reference color. Therefore, the engine control unit 301 obtains the color misregistration amount of each image in yellow, magenta, and cyan with respect to the image in black. Note that since the principle of obtaining the color misregistration amount is the same for each color, only the method of obtaining the color misregistration amount of cyan will be described below. Note that the reference color is not limited to black, and may be another color.

First, the color misregistration amount in the conveyance direction will be described. When no color misregistration in the conveyance direction occurs, both the distance in the conveyance direction between the image B1 and the image C1 and the distance in the conveyance direction between the image B2 and the image C2 are 2s+3w. By multiplying the difference between the detection timing of the image B1 and the detection timing of the image C1 by the moving speed of the surface of the transfer belt 27, the engine control unit 301 obtains BC #1, which is the first distance in the conveyance direction between the image B1 and the image C1. Similarly, by multiplying the difference between the detection timings of the image B2 and the image C2 by the moving speed of the surface of the transfer belt 27, the engine control unit 301 obtains BC #2, which is the second distance in the conveyance direction between the image B2 and the image C2. Then, the engine control unit 301 determines the color misregistration amount in the conveyance direction by subtracting an ideal distance (2s+3w) from the average value of BC #1, which is the first distance, and BC #2, which is the second distance. Note that the color misregistration amount having a positive value indicates that the image in cyan is shifted rearward from an ideal position, and the color misregistration amount having a negative value indicates that the image in cyan is shifted forward from the ideal position.

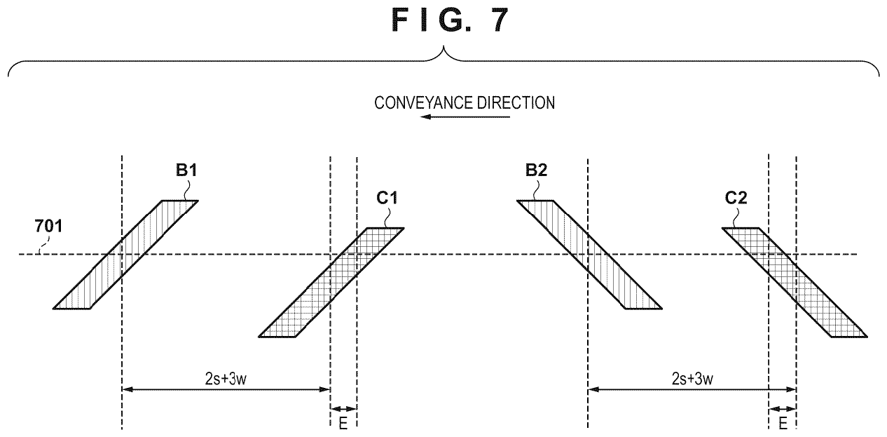

Next, the color misregistration amount in the width direction will be described. FIG. 7 illustrates a state where the image in cyan is shifted by a value E leftward toward the conveyance direction. Since each image has an angle of 45 degrees with respect to the conveyance direction, BC #1, which is the first distance in the conveyance direction between the image B1 and the image C1, is longer by the value E than the ideal distance (2s+3w). On the other hand, BC #2, which is the second distance in the conveyance direction between the image B2 and the image C2, is shorter by the value E than the ideal distance (2s+3w). As is obvious from FIG. 7, when BC #2, which is the second distance, is subtracted from BC #1, which is the first distance, the value thereof is 2E, which is twice the color misregistration amount. Therefore, the engine control unit 301 determines, as the color misregistration amount in the width direction, ½ of the value in which BC #2 is subtracted from BC #1. Note that the color misregistration amount having a positive value indicates that the image in cyan is shifted leftward toward the conveyance direction, and the color misregistration amount having a negative value indicates that the image in cyan is shifted rightward toward the conveyance direction.

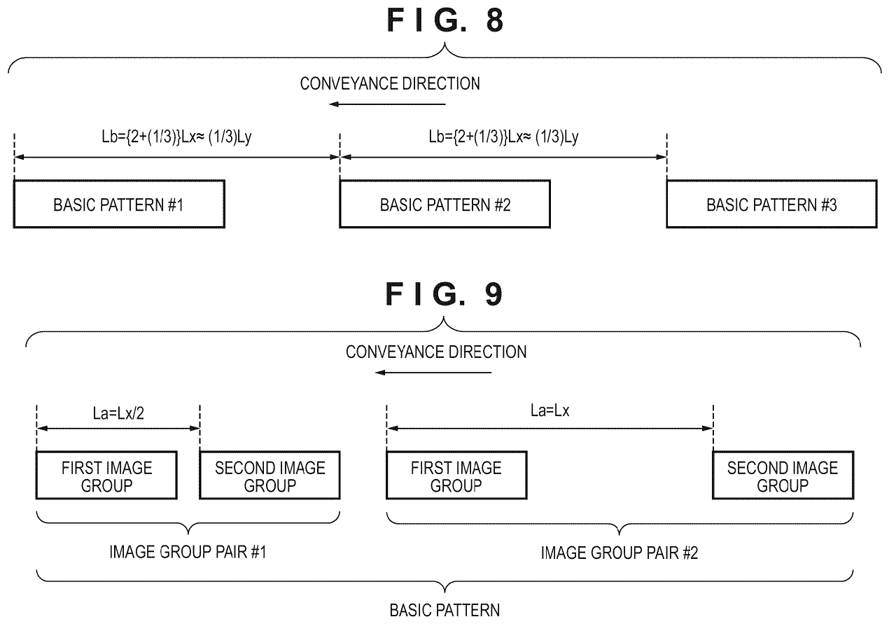

Next, a detection pattern formed on the transfer belt 27 in the color misregistration correction processing will be described. Note that the image forming apparatus 102 is assumed to be configured such that a circumference Ly of the transfer belt 27 is 760 [mm], and a movement amount of the surface of the transfer belt 27 in a period in which the photoreceptor 22 makes one rotation is Lx=108 [mm]. FIGS. 8 and 9 are explanatory views of detection patterns for suppressing influences of the “basic AC color misregistration”, a “second order AC color misregistration”, and a “third order AC color misregistration” of the photoreceptor 22 and the “basic AC color misregistration” of the transfer belt 27.

As described above, the basic AC color misregistration of the photoreceptor 22 is an AC color misregistration with a period in which the photoreceptor 22 makes one rotation as one period. This is also an AC color misregistration generated with the interval Lx as one period on the surface of the transfer belt 27. The second order AC color misregistration of the photoreceptor 22 is an AC color misregistration with a period in which the photoreceptor 22 makes half rotations as one period. This is also an AC color misregistration generated with an interval Lx/2 as one period on the surface of the transfer belt 27. The third order AC color misregistration of the photoreceptor 22 is an AC color misregistration with a period in which the photoreceptor 22 makes ⅓ rotations as one period. This is also an AC color misregistration generated with an interval Lx/3 as one period on the surface of the transfer belt 27. Similarly, the basic AC color misregistration of the transfer belt 27 is an AC color misregistration generated with a period in which the transfer belt 27 makes one rotation, i.e., on the surface of the transfer belt 27, with the interval Ly as one period.

In the detection pattern of the present example, as illustrated in FIG. 8, three basic patterns #1 to #3 are arranged at a pattern interval Lb={2+ (⅓)} Lx=252 [mm]. Note that the pattern interval Lb is a distance between the same positions of the same images of two consecutive basic patterns. The pattern interval Lb is also referred to as a first interval. In the present example, since the circumference Ly of the transfer belt 27 is 760 [mm], the pattern interval Lb is substantially equal to ⅓ of the circumference Ly of the transfer belt 27. As illustrated in FIG. 9, each basic pattern includes two image group pairs #1 and #2. The image group interval La (see FIG. 5) of the image group pair #1 is Lx/2=54 [mm], and the image group interval La of the image group pair #2 is Lx=108 [mm]. The image group interval La of the image group pair #1 is also referred to as a second interval, and the image group interval La of the image group pair #2 is also referred to as a third interval.

Note that the image group interval La is obtained as 5w+2s+g+h. Therefore, as an example, when g=24 [mm] for the image group pair #1, g=78 [mm] for the image group pair #2, and w=2 [mm], s=4 [mm], and h=12 [mm], the image group interval La described above is obtained.

Next, a method of determining the color misregistration amount based on the detection pattern described with reference to FIGS. 8 and 9 will be described. The detection pattern of the present embodiment includes three image group pairs #1 and three image group pairs #2. The reason will be described later, and in the present embodiment, the three image group pairs #1 are used to obtain the color misregistration amount in the conveyance direction, and the three image group pairs #2 are used to obtain the color misregistration amount in the width direction. More specifically, the average of the three color misregistration amounts in the conveyance direction obtained based on the respective detection results of the three image group pairs #1 is determined to be the color misregistration amount in the conveyance direction detected in the detection pattern. Similarly, the average of the three color misregistration amounts in the width direction obtained based on the respective detection results of the three image group pairs #2 is determined to be the color misregistration amount in the width direction detected in the detection pattern.

As illustrated in FIG. 4, the engine control unit 301 forms, on the transfer belt 27, a detection pattern detected by the sensor 6R and a detection pattern detected by the sensor 6L. In the following description, the detection pattern detected by the sensor 6R is referred to as a detection pattern R, and the detection pattern detected by the sensor 6L is referred to as a detection pattern L. The engine control unit 301 determines, as the final color misregistration amount in the conveyance direction in the color misregistration correction processing, the average of the color misregistration amount in the conveyance direction detected in the detection pattern R and the color misregistration amount in the conveyance direction detected in the detection pattern L. Similarly, the engine control unit 301 determines, as the final color misregistration amount in the width direction in the color misregistration correction processing, the average of the color misregistration amount in the width direction detected in the detection pattern R and the color misregistration amount in the width direction detected in the detection pattern L.

Furthermore, the engine control unit 301 can determine a scaling amount of the image in the width direction based on a difference between the color misregistration amount in the width direction detected in the detection pattern R and the color misregistration amount in the width direction detected in the detection pattern L. Furthermore, the engine control unit 301 can determine an inclination amount of the image based on a difference between the color misregistration amount in the conveyance direction detected in the detection pattern R and the color misregistration amount in the conveyance direction detected in the detection pattern L.

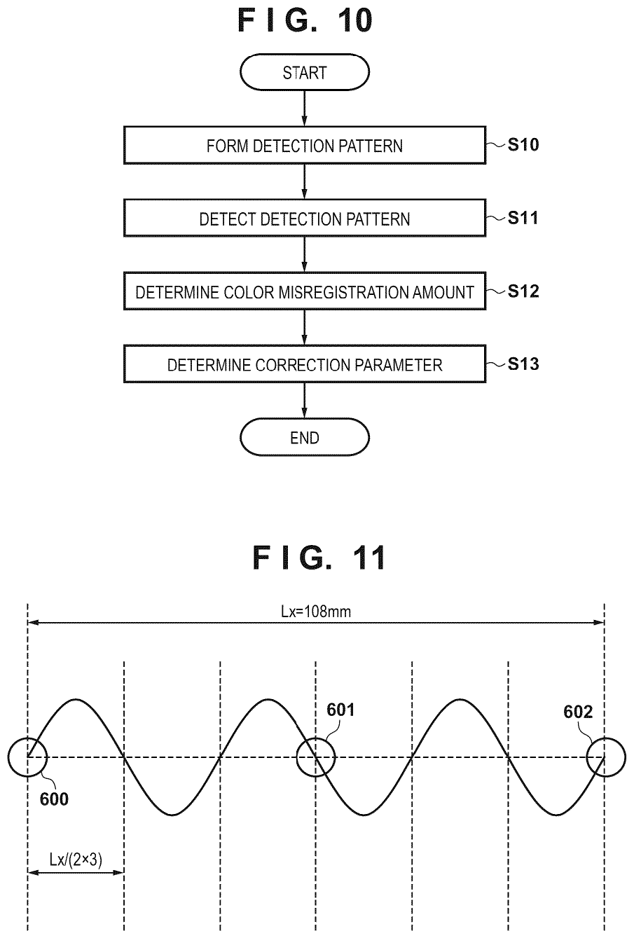

FIG. 10 is a flowchart of the color misregistration correction processing according to the present embodiment. Note that the image forming apparatus starts the color misregistration correction processing when a predetermined condition is satisfied. The predetermined condition can be satisfied, for example, when the power is turned on. The predetermined condition can be satisfied when a predetermined number of sheets are printed from the color misregistration correction processing of last time or when a predetermined time has elapsed from the color misregistration correction processing of last time. Furthermore, the predetermined condition can be satisfied when the internal temperature of the image forming apparatus fluctuates by a predetermined value or more. The image forming apparatus can start the color misregistration correction processing in response to a user's instruction.

In S10, the engine control unit 301 forms the detection pattern L and the detection pattern R on the transfer belt 27. In S11, the engine control unit 301 acquires a detection result of the detection pattern L from the sensor 6L and acquires a detection result of the detection pattern R from the sensor 6R. In S12, as described above, the engine control unit 301 determines the color misregistration amount in the width direction, the color misregistration amount in the conveyance direction, the scaling amount in the width direction, and the inclination amount of the image. In S13, based on the determination result in S12, the engine control unit 301 determines and saves a correction parameter for reducing the color misregistration amount in the width direction, the color misregistration amount in the conveyance direction, the scaling amount in the width direction, and the inclination amount of the image. In the subsequent image formation, the engine control unit 301 performs the image formation using this correction parameter.

Next, the reason that the three image group pairs #1 are used to obtain the color misregistration amount in the conveyance direction and the three image group pairs #2 are used to obtain the color misregistration amount in the width direction will be described. As illustrated in FIG. 8, the basic patterns are arranged at the pattern interval Lb={2+ (⅓)} Lx. That is, the three basic patterns are arranged with a phase difference of 2π/3 in the basic AC color misregistration in which the length of one period (=2π) is Lx on the transfer belt 27. For example, assuming that the phase of the arrangement position of the basic pattern #1 is a reference, that is, 0, the phases of the arrangement positions of the basic pattern #2 and the basic pattern #3 are 2π/3 and 4π/3, respectively. In this manner, since the three basic patterns are arranged over one period of the basic AC color misregistration with the same phase difference, it is possible to suppress an error due to the influence of the basic AC color misregistration included in the color misregistration amount determined in each basic pattern by averaging the respective detection results of the three detection patterns.

The length of one period of the second order AC color misregistration with half rotation of the photoreceptor 22 as one period=2π is Lx/2 on the transfer belt 27. In this case, the phases of the arrangement positions of the basic patterns #1, #2, and #3 are twice those in the case of the basic AC color misregistration. That is, the phases of the arrangement positions of the basic patterns #1, #2, and #3 in the case of the second order AC color misregistration are 2×0=0, 2× 2π/3=4π/3, and 2×4π/3=2π/3. In this manner, even in the second order AC color misregistration, the three basic patterns are arranged over one period with the same phase difference. Therefore, by averaging the respective detection results of the three detection patterns, it is possible to suppress an error due to the influence of the second order AC color misregistration included in the color misregistration amount determined in each basic pattern.

On the other hand, the length of one period of the third order AC color misregistration with ⅓ rotation of the photoreceptor 22 as one period=2π is Lx/3 on the transfer belt 27. In this case, the phases of the arrangement positions of the basic patterns #1, #2, and #3 are thrice those in the case of the basic AC color misregistration. That is, the phases of the arrangement positions of the basic patterns #1, #2, and #3 in the case of the third order AC color misregistration are 3× 0=0, 3×2π/3=0, and 3×4π/3=0, respectively. In this manner, in the case of the third order AC color misregistration, the phases of the arrangement positions of the basic patterns #1, #2, and #3 are the same. Therefore, in the case of the third order AC color misregistration, even if the average of the three detection patterns is obtained as in the basic AC color misregistration and the second order AC color misregistration, the influence thereof cannot be suppressed. Therefore, it is necessary to suppress the influence of the third order AC color misregistration in the color misregistration amount determined based on the respective detection results of the three detection patterns.

Here, as described with reference to FIG. 5, the color misregistration amount in the conveyance direction is obtained based on the average of the first distance in the conveyance direction measured in the first image group and the second distance in the conveyance direction measured in the second image group, that is, the sum of the first distance and the second distance. On the other hand, the color misregistration amount in the width direction is obtained based on the difference between the first distance and the second distance.

As described above, one period of the third order AC color misregistration is the distance Lx/3 on the transfer belt 27. In the image group pair #1, the distance in the conveyance direction between the first image group and the second image group is Lx/2. Hence, assuming that the phase of the first image group is 0, the phase of the second image group is, given that (Lx/2)/(Lx/3)=1.5. Therefore, in the third order AC color misregistration, the phase difference between the first image group and the second image group of the image group pair #1 is π, that is, the first image group and the second image group of the image group pair #1 have opposite phases. On the other hand, in the image group pair #2, the distance in the conveyance direction between the first image group and the second image group is Lx. Hence, assuming that the phase of the first image group is 0, the phase of the second image group is 0, given that (Lx)/(Lx/3)=3. Therefore, in the third order AC color misregistration, the phase difference between the first image group and the second image group of the image group pair #2 is 0, that is, the first image group and the second image group of the image group pair #2 are in phase.

This situation is illustrated in FIG. 11. Reference sign 600 in FIG. 11 denotes the first image groups of the image group pair #1 and the image group pair #2, and the phase thereof is 0. Reference sign 601 denotes the second image group of the image group pair #1, and reference sign 602 denotes the second image group of the image group pair #2. The sine wave in FIG. 11 indicates the color misregistration due to the third order AC color misregistration. As is obvious from FIG. 11, the phase of the second image group of the image group pair #1 is an opposite phase to the phase of the first image group of the image group pair #1, and the phase of the second image group of the image group pair #2 is in phase with the first image group of the image group pair #1.

Therefore, when the color misregistration amount in the conveyance direction is obtained by the image group pair #1, the error due to the third order AC color misregistration included in the first distance and the error due to the third order AC color misregistration included in the second distance are added in opposite phases and cancel each other. Note that when the color misregistration amount in the width direction is obtained by the image group pair #1, the error due to the third order AC color misregistration included in the first distance and the error due to the third order AC color misregistration included in the second distance are added in phase and remain.

Similarly, when the color misregistration amount in the width direction is obtained by the image group pair #2, the error due to the third order AC color misregistration included in the first distance and the error due to the third order AC color misregistration included in the second distance are added in opposite phases and cancel each other. Note that when the color misregistration amount in the conveyance direction is obtained by the image group pair #2, the error due to the third order AC color misregistration included in the first distance and the error due to the third order AC color misregistration included in the second distance are added in phase and remain.

For example, it is assumed that a basic pattern including only one of the image group pair #1 and the image group pair #2 illustrated in FIG. 9 is formed as illustrated in FIG. 8. Also in this case, regarding the basic AC color misregistration and the second order AC color misregistration, since the phases of the three basic patterns are different by 2π/3, the influence of the AC color misregistration can be suppressed by averaging the color misregistration amounts obtained respectively with the three basic patterns. However, as described above, regarding the third order AC color misregistration in which the arrangements of the three basic patterns are in phase, the influence of the AC color misregistration cannot be suppressed even by averaging the color misregistration amounts obtained respectively with the three basic patterns. For this reason, regarding the third order AC color misregistration, it is necessary to suppress the influence of the AC color misregistration in the respective color misregistration amounts obtained by each of the image group pairs. However, the influence of the third order AC color misregistration remains in the color misregistration amount in the width direction only with the image group pair #1, and the influence of the third order AC color misregistration remains in the color misregistration amount in the conveyance direction only with the image group pair #2. For this reason, in the present embodiment, the basic pattern is provided with two image group pairs having different image group intervals La, the color misregistration amount in the conveyance direction is determined in one image group pair, and the color misregistration amount in the width direction is determined in the other image group pair.

As described above, the distance between two adjacent basic patterns in the three basic patterns is substantially ⅓ of the circumference of the transfer belt 27. Therefore, the influence of the basic AC color misregistration of the transfer belt 27 can also be suppressed by averaging the color misregistration amounts obtained in the three basic patterns.

Note that in the above embodiment, the pattern interval of the three basic patterns is Lb={2+ (⅓)} Lx. By this, the three basic patterns are arranged so that the phases are different by 2π/3 in the basic AC color misregistration. Here, “2” of {2+ (⅓)} is a distance moved by the transfer belt 27 while the photoreceptor 22 makes two rotations, and even if it is an integer different from 2, it is obvious that the phases of the arrangement positions of the three basic patterns are different by 2π/3. That is, “2” of Lb={2+ (⅓)} Lx used in the embodiment is an example, and may be an arbitrary integer of 0 or more. On the other hand, “⅓” of {2+ (⅓)} indicates that the phases of the three basic patterns are arranged so as to be different by ⅓ of 2π.

Therefore, more generally speaking, the pattern interval Lb of the detection pattern including N basic patterns (N is an integer of 2 or more) can be Lb={S+ (1/N)} Lx. Here, S is an arbitrary integer of 0 or more. By this, on the transfer belt 27, the N basic patterns are arranged at positions at which the phases are different by 2π/N. Note that in the example of FIG. 8, N is 3. In the above example, the length of one detection pattern including the three basic patterns is similar to the circumference of the transfer belt 27, but when the circumference of the transfer belt 27 is long, a plurality of detection patterns may be formed, and by the average of the color misregistration amounts obtained in the respective detection patterns, whereby the correction parameter can be configured to be obtained.

In the example of FIG. 9, the image group interval La of the image group pair #1 is Lx/2=3Lx/6. However, as is obvious from FIG. 11, even if the image group interval La is Lx/6 or 5Lx/6, the phase difference between the first image group and the second image group of the image group pair #1 is π. Therefore, the image group interval La of the image group pair #1 can be an odd multiple of Lx/6 when N=3. More generally, in a case of a detection pattern including N basic patterns, the image group interval La of the image group pair #1 can be an odd multiple of Lx×(½N).

Similarly, in the example of FIG. 9, the image group interval La of the image group pair #2 is Lx=6Lx/6. However, as is obvious from FIG. 11, even if the image group interval La is 2Lx/6 or 4Lx/6, the phase difference between the first image group and the second image group of the image group pair #2 is 0. Therefore, the image group interval La of the image group pair #2 can be an even multiple of Lx/6 when N=3. More generally, in a case of a detection pattern including N basic patterns, the image group interval La of the image group pair #2 can be an even multiple of Lx×(½N).

In the above example, the distance moved by the surface of the transfer belt 27 during a period in which the photoreceptor 22 makes one rotation, that is, the rotation period of the photoreceptor 22 is Lx. However, in a case where the basic AC color misregistration occurs due to eccentricity of the motor that drives the photoreceptor 22, the distance moved by the surface of the transfer belt 27 during the rotation period of the motor can be Lx. Furthermore, the AC color misregistration having the longest period caused by the photoreceptor 22 or the driving member of the photoreceptor 22 can be the basic AC color misregistration of the photoreceptor 22, and the distance moved by the surface of the transfer belt 27 during this longest period can be Lx. Furthermore, in FIG. 9, the first image group and the second image group of the image group pair #1 are adjacently formed on the transfer belt 27, and next, the first image group and the second image group of the image group pair #2 are adjacently formed on the transfer belt 27. However, the formation order of the four image groups is not limited to that illustrated in FIG. 9, for example, the first image group of the image group pair #1, the first image group of the image group pair #2, the second image group of the image group pair #1, and the second image group of the image group pair #2 are formed in this order.

Furthermore, as illustrated in FIG. 5, in the present example, assuming that the clockwise direction is positive, the direction of each linear image of the first image group is −45 degrees with respect to the conveyance direction, and the direction of each linear image of the second image group is +45 degrees with respect to the conveyance direction. In this case, change amounts from ideal values of the first distance and the second distance are the same as the color misregistration amount in the width direction. However, if at least one of the first distance and the second distance changes from the ideal value in accordance with the color misregistration amount in the width direction and the change amounts of the first distance and the second distance are different, the color misregistration amount in the width direction can be determined.

Therefore, if a first angle with respect to the conveyance direction of the linear image of the first image group is not 0, a second angle with respect to the conveyance direction of the linear image of the second image group is not 0, and the first angle and the second angle are different from each other, the color misregistration amount in the width direction can be determined. Therefore, the first image group and the second image group are not limited to those illustrated in FIG. 5.

The above configuration can accurately determine the color misregistration amount of the DC color misregistration while suppressing the influence of the AC color misregistration caused by rotation of the photoreceptor 22 or rotation of the motor that drives the photoreceptor 22. Furthermore, in accordance with the pattern interval Lb, which is the distance between the basic patterns, and the circumference of the transfer belt 27, the influence by the AC color misregistration caused by rotation of the transfer belt 27 or the driving roller 25 that drives the transfer belt 27 can be suppressed.

### Second Embodiment

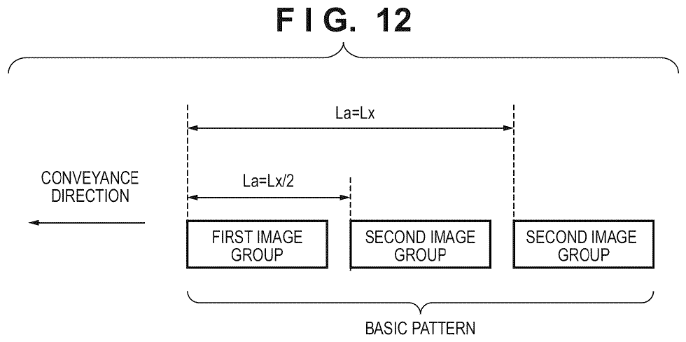

Next, a second embodiment will be described focusing on differences from the first embodiment. FIG. 12 illustrates the basic pattern according to the present embodiment. Note that the basic pattern is arranged as illustrated in FIG. 8. Note that the detection patterns illustrated in FIGS. 8 and 11 also suppress the influence of the “basic AC color misregistration”, the “second order AC color misregistration”, and the “third order AC color misregistration” of the photoreceptor 22 and the “basic AC color misregistration” of the transfer belt 27.

The basic pattern of the first embodiment includes the image group pair #1 and the image group pair #2, and the image group pair #1 and the image group pair #2 each include the first image group and the second image group. The basic pattern of the present embodiment is commonalized first image groups of the image group pair #1 and the image group pair #2 in the first embodiment. Therefore, the image group interval La between the first image group and one second image group is Lx/2, and the image group interval La between the first image group and the other second image group is Lx.

In the present embodiment, the number of the first image groups to be included in the basic pattern can be made smaller than that in the first embodiment, and hence the length in the conveyance direction of the basic pattern can be made shorter than that in the first embodiment. Therefore, the area between the basic patterns can be used for formation of a detection pattern for density correction, for example, and calibration can be efficiently performed such as concurrently performing color misregistration correction processing and density correction processing. The amount of toner consumed in color misregistration correction processing can be reduced.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-150878, filed Sep. 2, 2024, which is hereby incorporated by reference herein in its entirety.

What is claimed is:

1. An image forming apparatus comprising:
a plurality of photoreceptors that are rotationally driven and on which images of different colors are formed;
an image carrier that is rotationally driven and to which images formed on the plurality of photoreceptors are transferred;
a detection unit configured to detect an image transferred to the image carrier; and
a control unit configured to form, onto the image carrier, a detection pattern including a first image group including a plurality of first images of different colors and a second image group including a plurality of second images of different colors by forming a first image and a second image on each of the plurality of photoreceptors to transfer the first image and the second image to the image carrier, and determine a color misregistration amount in a rotational direction of the image carrier and a color misregistration amount in a width direction orthogonal to the rotational direction based on a detection result of the detection pattern by the detection unit, wherein
the first image is a linear image in a first direction different from the rotational direction,
the second image is a linear image in a second direction different from the rotational direction and the first direction,
the detection pattern includes a plurality of basic patterns arranged at a first interval in the rotational direction, and
each of the plurality of basic patterns includes the first image group and the second image group arranged at a second interval in the rotational direction, and the first image group and the second image group arranged at a third interval different from the second interval in the rotational direction.

2. The image forming apparatus according to claim 1, wherein the control unit uses a detection result by the detection unit of the first image group and the second image group arranged at the second interval in order to determine a color misregistration amount in the rotational direction, and uses a detection result by the detection unit of the first image group and the second image group arranged at the third interval in order to determine a color misregistration amount in the width direction.

3. The image forming apparatus according to claim 1, wherein the first image group in the first image group and the second image group arranged at the second interval is same as the first image group in the first image group and the second image group arranged at the third interval.

4. The image forming apparatus according to claim 1, wherein the first image group and the second image group arranged at the second interval are different from the first image group and the second image group, respectively, arranged at the third interval.

5. The image forming apparatus according to claim 1, wherein
the plurality of basic patterns are N basic patterns that are integers of 2 or more, and
the first interval, the second interval, and the third interval are intervals based on N.

6. The image forming apparatus according to claim 5, wherein the first interval corresponds to a distance moved by a surface of the image carrier during a period {S+ (1/N)} times a rotation period of the plurality of photoreceptors or a motor that drives the plurality of photoreceptors, and S is an integer of 0 or more.

7. The image forming apparatus according to claim 5, wherein
the second interval corresponds to a distance moved by a surface of the image carrier during a period an odd multiple of (½N) times a rotation period of the plurality of photoreceptors or a motor that drives the plurality of photoreceptors, and
the third interval corresponds to a distance moved by a surface of the image carrier moves during a period an even multiple of (½N) times the rotation period.

8. The image forming apparatus according to claim 5, wherein the first interval is an interval corresponding to a phase difference of 2π/N, when a distance moved by a surface of the image carrier during a period in which the plurality of photoreceptors or a motor that drives the plurality of photoreceptors makes one rotation is one period.

9. The image forming apparatus according to claim 5, wherein
the second interval is an interval at which the first image group and the second image group have opposite phases, when a distance moved by a surface of the image carrier during a period in which the plurality of photoreceptors or a motor that drives the plurality of photoreceptors makes one rotation is one period, and
the third interval is an interval at which the first image group and the second image group are in phase, when a distance moved by a surface of the image carrier during a period in which the plurality of photoreceptors or a motor that drives the plurality of photoreceptors makes one rotation is one period.
